(19) United States
(12) Patent Application Publication
(10) Pub. No.: US 2018/0105673 A1
(43) Pub. Date: Apr. 19, 2018

(54) PLASTICIZERS WHICH IMPROVE COMPATIBILITY IN PVC FORMULATIONS

(71) Applicant: Eastman Chemical Company, Kingsport, TN (US)

(72) Inventors: Curtis Louis Schilling, III, Kingsport, TN (US); Kelmara Khadene Kelly, Kingsport, TN (US)

(73) Assignee: Eastman Chemical Company, Kingsport, TN (US)

(21) Appl. No.: 15/786,661

(22) Filed: Oct. 18, 2017

Related U.S. Application Data
(60) Provisional application No. 62/409,446, filed on Oct. 18, 2016.

(51) Int. Cl. C08K 5/12; C08K 5/01

(52) U.S. Cl. CPC C08K 5/12; C08K 5/01

(57) ABSTRACT

A plasticizer has been identified that improves compatibility in PVC formulations where secondary plasticizers and viscosity modifiers are present. In general, 1,2- or 1,4-dialkyl cyclohexane dicarboxylate plasticizers exhibit poor compatibility, as evidenced by increased exudation, in the presence of secondary plasticizers, i.e. chlorinated paraffins and hydrocarbon-based viscosity modifiers. We have found that bis 1,4-(2-ethylhexyl) cyclohexane dicarboxylate (DOCH) displays the opposite behavior, showing greater compatibility in the presence of these compounds than most other 1,2- or 1,4-dialkyl cyclohexane dicarboxylate derivatives (i.e. DINCH) or blends of fast-fuser/general purpose plasticizers.

### FIELD OF THE INVENTION

This invention belongs to the field of plasticizers. In particular, it relates to certain esters of cyclohexane polycarboxylic acids.

### BACKGROUND OF THE INVENTION

The current PVC plasticizer market supplies many options to formulators with respect to PVC plastisols or dry blends. Each plasticizer has its own strength but all commercially viable plasticizers must have a basic set of performance characteristics. The plasticizer must be compatible with PVC resin(s), to provide flexibility. The plasticizer must aid in the fusion process, reducing the glass transition temperature (T_{g}) to a more manageable and safer temperature and facilitating the dissolution and distribution of molecules such that the final part is fully homogeneously dispersed.

Every business is cost conscious and PVC formulators are constantly looking for ways to remove cost from their processes. Of the various components found in a typical PVC formulation the PVC resin itself, filler, and the plasticizer, typically make up the largest weight fraction of the total composition. Any endeavor to reduce cost will typically focus on these three components. Cost can be taken out of the plasticizer charge by substituting some portion of the more expensive primary plasticizer with a lower cost secondary plasticizer. The secondary plasticizer is incapable of adequate performance on its own but can work in concert with the primary plasticizer to produce acceptable overall performance. The total formulation cost can also be reduced by replacing some of the PVC resin with filler. Filler is typically a chemically inert inorganic material that displaces some of the bulk of the PVC resin. The filler provides structural integrity at a significantly lower cost than the PVC resin. One potential negative associated with the use of filler is the impact on viscosity. Even the use of low levels of filler in a plastisol will increase the viscosity and can require the use of a viscosity reducer to keep the plastisol in a workable range for the intended production process. There are several classes of viscosity reducers but one common, and lower cost, class are hydrocarbon-based fluids. These reducers can be very effective in terms of viscosity control but have the potential downside of being less compatible with some of the other components in the formulation, most notably the plasticizer.

As continued regulatory pressure moves PVC formulators away from phthalate-based plasticizers, most PVC users will have to alter existing formulations to deal with the performance differences between phthalate and non-phthalate plasticizers. Compatibility, viscosity, and efficiency remain as challenges.

### SUMMARY OF THE INVENTION

In certain aspects, the invention relates to plasticizer compositions comprising compounds having the structure:

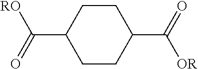

wherein R represents a C₁ to C₁₃ alkyl group, a C₂ to C₁₃ ether group, a C₃ to C₈ cycloalkane group, or an aromatic group; and when R is an alkyl group, wherein the total number of carbons in both alkyl groups is less than 18.

Another embodiment concerns a composition comprising a compound as described in the preceding paragraph and at least one compound represented by the following structure:

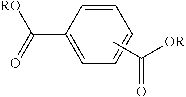

wherein the substitution pattern can be 1,2-, 1,3-, or 1,4-, and R represents a C₁ to C₁₃ alkyl group, a C₂ to C₁₃ ether group, a C₃-C₈ cycloalkane group, or an aromatic group.

Another embodiment provides a plastisol comprising one or more of the plasticizers described in the preceding paragraphs.

### DETAILED DESCRIPTION OF THE INVENTION

Plasticizers are often used in thermoplastic polymers, thermosetting polymers, and elastomeric polymers and numerous applications, including but not limited to plastisols, dry blends, adhesives, sealants, caulks, architectural coatings, industrial coatings, OEM coatings, inks, overprint varnishes, polishes, and the like. In particular, when used in thermoplastic polymers, they are utilized to improve flexibility of the polymer in general, and they improve fusion behavior by lowering the glass transition temperature T_{g} of the polymer. Without wishing to be bound by theory, plasticizers are believed to interact with the polymer chains in such thermoplastic polymers to speed up viscoelastic response and/or increase chain mobility.

One thermoplastic polymer which has been the subject of much study and commercial utilization is poly(vinyl chloride) (PVC). In such polymers, one often uses a combination of plasticizers and additives, targeting performance characteristics per a desired end use, while minimizing cost. In such plasticized PVC systems there is always a “primary plasticizer” and in some cases a “secondary plasticizer.”

The term “primary plasticizer” generally refers to molecules which are highly compatible with PVC up to at least about 150 per hundred parts resin (phr). Primary plasticizers tend to increase flexibility of the underlying polymer by directly interacting with the polymer. Primary plasticizers can often be described as “general purpose” or “highly solvating” (fast fusing) plasticizers. Highly solvating plasticizers tend to lower fusion temperatures and times, but can have a negative impact by raising viscosity of a plastisol.

Secondary plasticizers are generally incompatible with PVC on their own and tend to work “with” the primary plasticizer, extending the plasticization performance of a lower loading of primary plasticizer.

Among known plasticizers, bis 1,4-(2-ethylhexyl) cyclohexane dicarboxylate (DOCH) is a highly efficient, non-phthalate primary plasticizer. We have found that DOCH shows increased compatibility in PVC formulations where 1) high plasticizer loadings (100 phr and higher) are employed to achieve very soft PVC parts; 2) where lower cost secondary plasticizers are employed to replace some portion of the primary plasticizer and 3) where rheology is controlled by the use of viscosity modifiers.

We have discovered that DOCH behaves like a highly solvating plasticizer and, when used by itself or in combination with other plasticizers, shows improved performance compared to general purpose plasticizers including, but not limited to: DOP, DINP, DEHT, DINCH, and DPHP, in PVC formulations where the plasticizer loading is in the range of 60-120 phr.

Improved performance can be defined as: increased efficiency, as evidenced by lower Shore A hardness values; reduced viscosity and enhanced viscosity stability over time in both filled and unfilled plastisols; enhanced compatibility with secondary plasticizers; and improved fusion characteristics in the form of lower fusion temperatures and shorter fusion times.

In one embodiment the invention concerns a dialkyl cyclohexane dicarboxylate derivative that exhibits increased efficiency, improved compatibility as a sole plasticizer or in combination with other primary/secondary plasticizers and/or hydrocarbon fluid-based viscosity reducers, exhibits viscosity management in filled/unfilled systems, and enhances fusion characteristics in PVC plastisols.

Secondary plasticizers are typically utilized in conjunction with primary plasticizers to either reduce overall plasticizer cost or to obtain improvement in electrical or low temperature properties. The secondary plasticizer affords some plasticization performance with an attendant reduction in formulation cost. In the continually pressured regulatory environment exceptional primary plasticizers such as dioctyl phthalate (DOP) and di-isononyl phthalate (DINP) are currently disfavored. Non-phthalate alternatives, such as DEHT and DINCH don't possess the superior solvating behavior of DOP and DINP. As such, the use of secondary PZs with these non-phthalate alternatives can exceed the compatibility regime and result in exudation of either the primary or secondary plasticizer to the surface of the plastic. Exudation can result in surface imperfections, physical property degradation, and a loss of aesthetic properties. Examples of secondary plasticizers include, but are not limited to, chlorinated paraffins, epoxidized soybean oil, naphthenic hydrocarbons, aliphatic hydrocarbons, and alkylated aromatic hydrocarbons. Among the more common secondary plasticizers are the chlorinated paraffins, which are hydrocarbons chlorinated to a level of about 30-70%.

As used, herein, the term “plastisol” refers to a liquid dispersion of polymeric resin particles, optionally with other ingredients, in a plasticizer. The term “fused plastisol” refers to the solid plastic material that is formed upon fusing the plastisol and subsequently cooling to a desired temperature. The term “fusing” refers to heating of the plastisol to a temperature sufficient to yield a solid structure with mechanical integrity upon cooling.

In addition to the plasticizer, the plastisol comprises a polymeric component. In one embodiment, the polymeric component comprises poly(vinyl chloride), poly(vinyl acetate), acrylic polymers and/or vinyl chloride-containing copolymers. In one embodiment, the polymeric component comprises poly(vinyl chloride) and/or poly(vinyl acetate). In another embodiment the polymeric component comprise poly(vinyl chloride) and vinyl chloride-containing copolymers comprising acrylic monomeric residues. In one aspect, the polymeric component is poly(vinyl chloride).

One common use of polyvinyl chloride is in a plastisol. Plastisols are ubiquitous in the production of components for the flooring, medical, automotive, consumer products, and construction markets. Plastisols may utilize a wide range of plasticizer loadings, from 40 phr or less in semi-rigid applications, to 600 phr for very flexible formulations that produce fishing worms. Plastisols typically employ polyvinyl chloride resins with particle sizes in the range of 2 to 70 microns, which are commonly produced via emulsion polymerization. A plastisol can be produced either “in-house” or sourced from a plastisol producer.

Accordingly, in one aspect the present invention provides a plastisol comprising:
a. 20 to 150 parts per hundred resin (phr) of total plasticizer, comprising 20 to 150 phr of bis 1,4-(2-ethylhexyl)cyclohexane, and optionally 0 to 130 phr of a general purpose plasticizer;
b. 5 to 50 phr of a secondary plasticizer; and
c. 100 phr of poly(vinyl chloride);

wherein said plastisol exhibits a loop spew grade at 23 of 0 to 1, as determined by ASTM 3291.

In another embodiment, the present invention provides a plastisol comprising:
a. 40 to 100 parts per hundred resin (phr) of total plasticizer, comprising 40 to 100 phr of bis 1,4-(2-ethylhexyl)cyclohexane, and optionally 0 to 60 phr of a general purpose plasticizer;
b. 10 to 30 phr of a secondary plasticizer; and
c. 100 phr of poly(vinyl chloride);

wherein said plastisol exhibits a loop spew rating at 23° C. of 0 to 1, as determined by ASTM ID 3291.

In another embodiment, the present invention provides a plastisol comprising:
a. 50 to 80 parts per hundred resin (phr) of total plasticizer, comprising 50 to 80 phr of bis 1,4-(2-ethylhexyl)cyclohexane, and optionally 0 to 30 phr of a general purpose plasticizer;
b. 20 to 25 phr of a secondary plasticizer; and
c. 100 phr of poly(vinyl chloride);

wherein said plastisol exhibits a loop spew rating at 23° C. of 0 to 1, as determined by ASTM D 3291.

It is common in some plastisol formulations to substitute a substantially chemically inert material to replace some of the polyvinyl chloride in the formulation. The inert material is commonly called filler and can significantly reduce the cost of the formulation. Non-limiting examples of fillers include calcium carbonate, magnesium carbonate, silica, clay, mica, graphite, fly ash, zinc oxide, and/or calcium oxide. In one aspect, the fillers comprise calcium carbonate. The use of fillers in the formulation will increase the plastisol viscosity and there is typically a need to add a viscosity modifier to the formulation to offset the viscosity increase. There are a variety of viscosity reducers but one common class could be categorized as hydrocarbon fluids. While highly effective, hydrocarbon fluids have limited compatibility in PVC. In those situations where the viscosity reducer is incompatible with a component in the formulation the end result can be exudation. Exudation can manifest itself as an oily sheen on the fused PVC article. It can also cause reduced performance due to plasticizer migration out of the PVC matrix. We have found that DOCH shows exceptional compatibility with this and other classes of viscosity modifiers, reducing or eliminating the exudation seen in some formulations.

In this embodiment the term “viscosity modifier” means a low viscosity liquid, typically containing (but not limited to) C₁₀-C₁₆ hydrocarbon oils, which are used to reduce the viscosity of a plastisol.

Accordingly, in another aspect, the present invention provides a plastisol comprising:
a. 20 to 150 parts per hundred resin (phr) of total plasticizer, comprising 20 to 150 phr of bis 1,4-(2-ethylhexyl)cyclohexane, and optionally 0 to 130 phr of a general purpose plasticizer;
b. 0.25 to 5 phr of a viscosity modifier;
c. 100 phr of poly(vinyl chloride); and,
d. 1 to 400 phr of filler;

wherein said plastisol exhibits a loop spew rating at 23° C. of 0 to 1, as determined by ASTM D 3291.

In another embodiment, the present invention provides a plastisol comprising:
a. 40 to 100 parts per hundred resin (phr) of total plasticizer, comprising 40 to 100 phr of bis 1,4-(2-ethylhexyl)cyclohexane, and optionally 0 to 60 phr of a general purpose plasticizer;
b. 1 to 5 phr of a viscosity modifier;
c. 100 phr of poly(vinyl chloride); and,
d. 100 to 300 phr filler;

wherein said plastisol exhibits a loop spew rating at 23° C. of 0 to 1, as determined by ASTM ID 3291.

In another embodiment, the present invention provides a plastisol comprising:
a. 50 to 80 parts per hundred resin (phr) of total plasticizer, comprising 50 to 80 phr of bis 1,4-(2-ethylhexyl)cyclohexane, and optionally 0 to 30 phr of a general purpose plasticizer;
b. 1.5 to 5 phr of a viscosity modifier;
c. 100 phr of poly(vinyl chloride); and,
d. 150 to 250 phr of filler;

wherein said plastisol exhibits a loop spew rating at 23° C. of 0 to 1, as determined by ASTM D 3291.

The viscosity of the plastisol can vary over a wide range but, for practical purposes, there is a minimum/maximum viscosity limit for every production process. The impact of shear on the plastisol viscosity is also important as the shear regime of a process changes significantly with respect to the equipment employed. Additionally, some mixtures can exhibit shear-thinning or shear-thickening behavior (dilatency). Dilatency can negatively impact a production process by creating excessive pressure at roll nips, doctor blades, and coating rolls. Coupled with the impact of shear, viscosity stability over time is important in a production process where plastisol may need to be stored for several days. The ability to consistently control the viscosity of a plastisol in a production process is highly valuable.

In one aspect, the plastisol has a workable viscosity of less than 50,000 cP at 23° C. In another aspect the plastisol viscosity has Newtonian characteristics, i.e., is relatively shear insensitive; i.e., the plastisol viscosity shear rate is in the range of 0.1 to 100 sec⁻¹. In another aspect the plastisol viscosity is stable for time periods in excess of 7 days.

In another aspect, additives to control rheology can be incorporated into the plastisols. These may include secondary plasticizers or diluents. Examples of such additives include petroleum distillates; hydrocarbon oils such as, for example, mineral oil and mineral spirits; fatty acid esters; polyphenyl oligomers, optionally partially hydrogenated; and organic solvents.

Accordingly, in another aspect, the present invention provides a plastisol comprising:
a. 20 to 150 parts per hundred resin (phr) of total plasticizer, comprising 20 to 150 phr of bis 1,4-(2-ethylhexyl)cyclohexane, and optionally 0 to 120 phr of a general purpose plasticizer;
b. 0.25 to 5 phr of a viscosity modifier;
c. 100 phr of poly(vinyl chloride); and,
d. 1 to 400 phr of filler;

wherein said plastisol exhibits a viscosity of 50,000 cP, an absence of dilatency by showing newtonian behavior over a range of shear, and a stability in excess of seven days as indicated by a viscosity increase of <10%.

In another embodiment, the present invention provides a plastisol comprising:
a. 40 to 100 parts per hundred resin (phr) of total plasticizer, comprising 40 to 100 phr of bis 1,4-(2-ethylhexyl)cyclohexane, and optionally 39 to 100 phr of a general purpose plasticizer;
b. 1 to 5 phr of a viscosity modifier;
c. 100 phr of poly(vinyl chloride); and,
d. 100 to 300 phr filler;

wherein said plastisol exhibits a viscosity of <40,000 cP, an absence of dilatency by showing newtonian behavior over a range of shear, and a stability in excess of seven days as indicated by a viscosity increase of <10%.

In another embodiment, the present invention provides a plastisol comprising:
a. 50 to 80 parts per hundred resin (phr) of total plasticizer, comprising 50 to 80 phr of bis 1,4-(2-ethylhexyl)cyclohexane, and optionally 49 to 80 phr of a general purpose plasticizer;
b. 1.5 to 5 phr of a viscosity modifier;
c. 100 phr of poly(vinyl chloride); and,
d. 150 to 250 phr of filler;

wherein said plastisol exhibits a viscosity of <30,000 cP, an absence of dilatency by showing newtonian behavior over a range of shear, and a stability in excess of seven days as indicated by a viscosity increase of <10%.

In one aspect, the plastisol comprises more than one plasticizer {i.e., further comprising}. In one aspect the additional plasticizers may comprise phthalates; terephthalates; isophthalates; trimellitates; adipates; cyclohexanedicarboxylates; benzoates; phosphates; diesters of ethylene glycol, propylene glycol, their oligomers, and mixtures thereof; citrates; succinates; alkyl sulfonates; fatty acid esters and epoxidized fatty acid esters; triglycerides and epoxidized triglycerides, optionally substituted; dianhydrohexitol diesters; pentaerythritol-based tetraesters; furan-based esters; other esters; ketals; and/or other polymeric plasticizers. In another aspect, the additional plasticizers may comprise dioctyl terephthalate, diisooctyl phthalate, di-2-ethylhexyl phthalate, di-2-ethylhexyl terephthalate, tri-2-ethylhexyl trimellitate, di-2-propylheptyl phthalate, diisononyl phthalate, diisodecyl phthalate, diisoundecyl phthalate, di-butyl terephthalate, ditridecyl phthalate, trioctyl trimellitate, triisononyl trimellitate, 2,2,4-trimethyl-1,3-pentanediol diisobutyrate, isononyl benzoate, isodecyl benzoate, diisononyl 1,2-cyclohexanedicarboxylate, dioctyl adipate, di-2-ethylhexyl adipate, triethylene glycol di-2-ethylhexanoate, diethylene glycol dibenzoate, dipropylene glycol dibenzoate, and/or dibenzoates produced from mixtures of diethylene glycol and dipropylene glycol. In one aspect, the second plasticizer comprises dioctyl terephthalate, di-2-ethylhexyl terephthalate, dioctyl adipate, di-2-ethylhexyl adipate, and/or triethylene glycol di-2-ethylhexanoate. In one aspect, the additional plasticizers may comprise, di-2-ethylhexyl terephthalate, diisononyl phthalate, di-butyl terephthalate, and/or diisononyl 1,2-cyclohexanedicarboxylate.

Accordingly, in another aspect, the present invention provides a plastisol comprising:
a. 20 to 150 parts per hundred resin (phr) of a general purpose plasticizer;
b. optionally, 1 to 50 parts per hundred resin (phr) of a highly solvating plasticizer;
c. 1 to 50 parts per hundred resin (phr) of bis 1,4-(2-ethylhexyl)cyclohexane;
d. 0.25 to 5 phr of a viscosity modifier;
e. 100 phr of poly(vinyl chloride); and,
f. 1 to 400 phr of filler;

wherein said plastisol has a lower fusion temperature when compared to a plastisol containing only the general purpose plasticizer.

In another embodiment the present invention provides a plastisol comprising:
a. 40 to 100 parts per hundred resin (phr) of a general purpose plasticizer;
b. optionally, 5 to 40 parts per hundred resin (phr) of a highly solvating plasticizer
c. 5 to 40 parts per hundred resin (phr) of bis 1,4-(2-ethylhexyl)cyclohexane;
d. 1 to 5 phr of a viscosity modifier;
e. 100 phr of poly(vinyl chloride); and,
f. 100 to 350 phr of filler;

wherein said plastisol has a lower fusion temperature when compared to a plastisol containing only the general purpose plasticizer.

In another embodiment the present invention provides a plastisol comprising:
a. 50 to 80 parts per hundred resin (phr) of a general purpose plasticizer;
b. optionally, 15 to 30 parts per hundred resin (phr) of a highly solvating plasticizer
c. 5 to 10 parts per hundred resin (phr) of bis 1,4-(2-ethylhexyl)cyclohexane;
d. 1.5 to 5 phr of a viscosity modifier;
e. 100 phr of poly(vinyl chloride); and,
f. 0 to 400 phr of filler;

wherein said plastisol has a lower fusion temperature when compared to a plastisol containing only the general purpose plasticizer.

In one aspect, the plastisol comprises elastomeric materials. Nonlimiting examples of elastomeric materials include nitrile-butadiene rubber, natural rubber, isoprene rubber, butadiene rubber, styrene-butadiene rubber, butyl rubber, ethylene-propylene-diene monomer (EPDM) rubber, chloroprene rubber, styrenated block copolymers, ethylene-vinyl acetate copolymers, olefinic elastomers, olefinic copolymer elastomers, silicone elastomers, polysulfide elastomers, and/or polyurethane elastomers.

### Examples

The saturated plasticizers were all prepared via the same general hydrogenation protocol (conditions listed below).

### Supported Pd Catalyst

### 160-220° C.

### 500-3500 psi H₂

0.2-10 LHSV (liquid hourly space velocity, volumetric flow rate/catalyst volume).

All plasticizer samples were evaluated as PVC plastisols. The standard protocol for preparing a plastisol is as follows: The components of the formulation (PVC resin, stabilizer, Epoxidized Soybean Oil (ESO), and plasticizer) are weighed into an appropriately sized FlackTek SpeedMixer™ mixing cup. The plastisol is mixed using two cycles on the mixer. The plastisol is de-aerated under vacuum with agitation for 1 hour. The de-aerated plastisol is poured into the appropriate mold and then fused at 375° F. for 30 minutes. The fused PVC parts are allowed to stand overnight before subsequent testing.

List of Acronyms:

phr: parts per hundred parts resin
Geon 121A: PVC Dispersion resin, K74
DOP: bis-2-ethylhexyl phthalate, dioctyl phthalate
DINP: diisononyl phthalate
DIDP: diisodecyl phthalate
DEHT (or “DOTP”): bis-2-ethylhexyl terephthalate, dioctyl terephthalate, or Eastman 168™
DINT: diisononyl terephthalate
Drapex 6.8: epoxidized soybean oil
Akcros LT-4798: mixed metal soap heat and light stabilizer
Viscobyk 4010: petroleum based viscosity modifier
Cereclor S-52: chlorinated paraffin
H2 DOP: 1,2-di-2-ethylhexylcyclohexane dicarboxylate
DI NCH: 1,2-diisononylcyclohexane dicarboxylate
H2 DIDP: 1,2-diisodecylcyclohexane dicarboxylate
DOCH: 1,4-di-2-ethylhexylcyclohexane dicarboxylate
H2 DINT: 1,4-diisononylcyclohexane dicarboxylate

Table One shows the formulation data for the high phr plastisols.

Table Two: Formulation table for ortho-phthalates with secondary plasticizers.

Table Three: Formulation table for DEHT/DBT blends with secondary PZ.

Table Four: Formulation table for hydrogenated analogs.

All samples were evaluated via the Loop Spew method, as described in ASTM D3291. Samples were tested at four hour/one day/seven day intervals. Graphs below illustrated the performance. Those categories with an asterisk indicate “spontaneous exudation” where the samples had noticeable exudation immediately after the sample was fused.

Example One: Exudation results for DOP at high PHR and with secondary PZ's.

Example Two: Exudation results for DINP at high PHR and with secondary PZ's.

Example Three: Exudation results for DIDP at high PHR and with secondary PZ's.

Example Four: Exudation results for DEHT at high PHR and with secondary PZ's.

Example Five: Exudation results for DINT at high PHR and with secondary PZ's.

Example Six: Exudation results for 85/15 blend of DEHT/DBT at high PHR and with secondary PZ's.

Example Seven: Exudation results for 70/30 blend of DEHT/DBT at high PHR and with secondary PZ's.

Example Eight: Exudation results for H2 DOP at high PHR and with secondary PZ's.

Example Nine: Exudation results for DINCH at high PHR and with secondary PZ's.

Example Ten: Exudation results for H2 DIDP at high PHR and with secondary PZ's.

Example Eleven: Exudation results for DOCH at high PHR and with secondary PZ's.

Example Twelve: Exudation results for H2 DINT at high PHR and with secondary PZ's.

The initial set of samples consisted of controls (current commercial offerings) that were tested at higher plasticizer loading (100 phr) looking for exudation. These samples include: DOP, DINP, DIDP, DINT and DEHT. The control samples were then tested in the presence of 20 phr of secondary PZ's, previously determined to cause compatibility issues. The secondary PZ's include: Viscobyk 4010 and Cereclor S-52. Viscobyk 4010 is medium volatile aliphatic hydrocarbon with acid wetting and dispersing components. Cereclor S52 is a mid-chain (C14-C17) chlorinated paraffin. Saturated analogs of all the controls were prepared (via hydrogenation of the starting molecule), in the same method as saturated DEHT, and tested in a protocol similar to the original controls, i.e. 100 phr, and 60 phr with 20 phr secondary present. Similarly, blends of DEHT/DBT were evaluated with respect to high phr loadings and the presence of secondary plasticizers or viscosity modifiers.

TABLE ONE
High phr plastisol formulation

| | DOP | DINP | DIDP | DEHT | DINT |
|---|---|---|---|---|---|
| Material | phr | phr | phr | phr | phr |
| Geon 121A | 100 | 100 | 100 | 100 | 100 |
| Plasticizer | 100 | 100 | 100 | 100 | 100 |
| Drapex 6.8 | 3 | 3 | 3 | 3 | 3 |
| Akros LT4798 | 3 | 3 | 3 | 3 | 3 |

TABLE TWO
Formulation table for ortho-phthalates with secondary plasticizers.

| | DOP | | DINP | | DIDP | | DEHT | | DINT | |
|---|---|---|---|---|---|---|---|---|---|---|
| Material | phr | | phr | | phr | | phr | | phr | |
| Geon 121A | 100 | 100 | 100 | 100 | 100 | 100 | 100 | 100 | 100 | 100 |
| Plasticizer | 60 | 60 | 60 | 60 | 60 | 60 | 60 | 60 | 60 | 60 |
| Viscobyk 4010 | | 20 | | 20 | | 20 | | 20 | | 20 |
| Cereclor S-52 | 20 | | 20 | | 20 | | 20 | | 20 | |
| Drapex 6.8 | 3 | 3 | 3 | 3 | 3 | 3 | 3 | 3 | 3 | 3 |
| Akros LT4798 | 3 | 3 | 3 | 3 | 3 | 3 | 3 | 3 | 3 | 3 |

TABLE THREE
Formulation table for DEHT/DBT blends with secondary PZ

| | 85/15 | 85/15 | 85/15 | 70/30 | 70/30 | 70/30 |
|---|---|---|---|---|---|---|
| ex000840- | DEHT/ | DEHT/ | DEHT/ | DEHT/ | DEHT/ | DEHT/ |
| 062- | DBT | DBT | DBT | DBT | DBT | DBT |
| Material | phr | phr | phr | phr | phr | phr |
| Geon 121A | 100 | 100 | 100 | 100 | 100 | 100 |
| Plasticizer | 100 | 60 | 60 | 100 | 60 | 60 |
| Viscobyk | 0 | 20 | 0 | 0 | 20 | 0 |
| 4010 | | | | | | |
| Cereclor S- | 0 | 0 | 20 | 0 | 0 | 20 |
| 52 | | | | | | |
| Drapex 6.8 | 3 | 3 | 3 | 3 | 3 | 3 |
| Akros | 3 | 3 | 3 | 3 | 3 | 3 |
| LT4798 | | | | | | |

TABLE FOUR
Formulation table for hydrogenated analogs

| | H2 DOP | | | DINCH | | | H2 DIDP | | | H2 DINT | | | DOCH | | |
|---|---|---|---|---|---|---|---|---|---|---|---|---|---|---|---|
| Material | phr | phr | phr | phr | phr | phr | phr | phr | phr | phr | phr | phr | phr | phr | phr |
| Geon 21A | 100 | 100 | 100 | 100 | 100 | 100 | 100 | 100 | 100 | 100 | 100 | 100 | 100 | 100 | 100 |
| Plasticizer | 100 | 60 | 60 | 100 | 60 | 60 | 100 | 60 | 60 | 100 | 60 | 60 | 100 | 60 | 60 |
| Viscobyk 4010 | 0 | 20 | 0 | 0 | 20 | 0 | 0 | 20 | 0 | 0 | 20 | 0 | 0 | 20 | 0 |
| Cereclor S-52 | 0 | 0 | 20 | 0 | 0 | 20 | 0 | 0 | 20 | 0 | 0 | 20 | 0 | 0 | 20 |
| Drapex 6.8 | 3 | 3 | 3 | 3 | 3 | 3 | 3 | 3 | 3 | 3 | 3 | 3 | 3 | 3 | 3 |
| Akros LT4798 | 3 | 3 | 3 | 3 | 3 | 3 | 3 | 3 | 3 | 3 | 3 | 3 | 3 | 3 | 3 |

TABLE 5

| | 4 Hour | | | | 24 Hour | | | | 1 Week | | | |
|---|---|---|---|---|---|---|---|---|---|---|---|---|
| | High | Viscobyk | Viscobyk | Cereclor | High | Viscobyk | Viscobyk | Cereclor | High | Viscobyk | Viscobyk | Cereclor |
| PZ | PHR | 4041 | 4010 | S52 | PHR | 4041 | 4010 | S52 | PHR | 4041 | 4010 | S52 |
| DOP | 0 | 2 | 2.8 | 0.5 | 0 | 0 | 1.3 | 1 | 0 | 0 | 0 | 1 |
| (Example | | | | | | | | | | | | |
| One) | | | | | | | | | | | | |
| DINP | 0.5 | 2.3 | 3 | 2 | 0.8 | 0.3 | 2.8 | 2.8 | 0 | 0 | 0 | 2 |
| (Example | | | | | | | | | | | | |
| Two) | | | | | | | | | | | | |
| DIDP | 1 | 2 | 3 | 2.5 | 1 | 1.3 | 1.5 | 3 | 0 | 0.5 | 0 | 2.5 |
| (Example | | | | | | | | | | | | |
| Three) | | | | | | | | | | | | |
| DEHT | 2.5 | 2.5 | 3 | 2.8 | 3 | 2.8 | 3 | 2.8 | 3 | 1 | 3 | 3 |
| (Example | | | | | | | | | | | | |
| Four) | | | | | | | | | | | | |
| DINT | 3 | 3* | 3* | 3 | 3 | 3* | 3 | 3 | 2.8 | 3* | 3* | 3 |
| (Example | | | | | | | | | | | | |
| Five) | | | | | | | | | | | | |
| 85:15 | 2.3 | 3 | 3 | 2 | 2 | 3 | 3 | 3 | 1 | 0.8 | 3 | 3 |
| (Example | | | | | | | | | | | | |
| Six) | | | | | | | | | | | | |
| 70:30 | 2 | 3* | 3* | 1.5 | 1.5 | 3* | 3* | 2 | 2 | 3* | 3* | 3 |
| (Example | | | | | | | | | | | | |
| Seven) | | | | | | | | | | | | |
| H2 DOP | 0 | 1.5 | 3* | 0.5 | 0 | 1.5 | 3* | 0.5 | 0 | 0 | 3* | 0 |
| (Example | | | | | | | | | | | | |
| Eight) | | | | | | | | | | | | |
| H2 DINP | 1 | 3* | 3* | 0.5 | 0.8 | 3* | 3* | 2.3 | 0 | 3* | 3* | 2.5 |
| (Example | | | | | | | | | | | | |
| Nine) | | | | | | | | | | | | |
| H2 DIDP | 1 | 3* | 3* | 1.5 | 0.8 | 3* | 3* | 2.8 | 0 | 3* | 3* | 3 |
| (Example | | | | | | | | | | | | |
| Ten) | | | | | | | | | | | | |
| H2 DINP | 1 | 3* | 0 | 1.8 | 0.3 | 3* | 0 | 2.8 | 0 | 3* | 0 | 1 |
| (Example | | | | | | | | | | | | |
| Eleven) | | | | | | | | | | | | |
| H2 DINT | 2.5 | 3* | 3* | 2.5 | 1.3 | 3* | 3* | 3 | 0 | 3* | 3* | 3 |
| (Example | | | | | | | | | | | | |
| Twelve) | | | | | | | | | | | | |

Entries with * indicate spontaneous exudation
Viscobyk 4041 and 4010 are hydrocarbon-based viscosity reducers.
Cereclor S52 is a chlorinated paraffin used as a secondary plasticizer and flame retardant additive
Geon 121A (now Vestolit G 121A) from Vestolit
Drapex from Galata Chemicals
Akcros LT4798 from Akcros Chemicals

The invention has been described in detail with particular reference to preferred embodiments thereof, but it will be understood that variations and modifications can be effected within the spirit and scope of the invention.

We claim:

1. A plastisol comprising:
a. 20 to 150 parts per hundred resin (phr) of total plasticizer, comprising 20 to 150 phr of bis 1,4-(2-ethylhexyl)cyclohexane, and optionally 0 to 130 phr of a general purpose plasticizer;
b. 5 to 50 phr of a secondary plasticizer; and
c. 100 phr of poly(vinyl chloride);
wherein said plastisol exhibits a loop spew grade at 23° C. of 0 to 1, as determined by ASTM D 3291.

2. The plastisol of claim 1, comprising:
a. 40 to 100 parts per hundred resin (phr) of total plasticizer, comprising 40 to 100 phr of bis 1,4-(2-ethylhexyl)cyclohexane, and optionally 0 to 60 phr of a general purpose plasticizer;
b. 10 to 30 phr of a secondary plasticizer; and
c. 100 phr of poly(vinyl chloride).

3. The plastisol of claim 2, comprising:
a. 50 to 80 parts per hundred resin (phr) of total plasticizer, comprising 50 to 80 phr of bis 1,4-(2-ethylhexyl)cyclohexane, and optionally 0 to 30 phr of a general purpose plasticizer;
b. 20 to 25 phr of a secondary plasticizer; and
c. 100 phr of poly(vinyl chloride).

4. A plastisol comprising:
a. 20 to 150 parts per hundred resin (phr) of total plasticizer, comprising 20 to 150 phr of bis 1,4-(2-ethylhexyl)cyclohexane, and optionally 0 to 130 phr of a general purpose plasticizer;
b. 0.25 to 5 phr of a viscosity modifier;
c. 100 phr of poly(vinyl chloride); and,
d. 1 to 400 phr of filler;
wherein said plastisol exhibits a loop spew rating at 23° C. of 0 to 1, as determined by ASTM D 3291.

5. The plastisol of claim 4, wherein said plastisol exhibits a viscosity of <50,000 cP, an absence of dilatency by showing newtonian behavior over a range of shear, and a stability in excess of seven days as indicated by a viscosity increase of <10%.

6. The plastisol of claim 4, comprising:
a. 40 to 100 parts per hundred resin (phr) of total plasticizer, comprising 40 to 100 phr of bis 1,4-(2-ethylhexyl)cyclohexane, and optionally 0 to 60 phr of a general purpose plasticizer;
b. 1 to 5 phr of a viscosity modifier;
c. 100 phr of poly(vinyl chloride); and,
d. 100 to 300 phr filler.

7. The plastisol of claim 6 wherein said plastisol exhibits a viscosity of <40,000 cP, an absence of dilatency by showing newtonian behavior over a range of shear, and a stability in excess of seven days as indicated by a viscosity increase of <10%.

8. The plastisol of claim 6, comprising:
a. 50 to 80 parts per hundred resin (phr) of total plasticizer, comprising 50 to 80 phr of bis 1,4-(2-ethylhexyl)cyclohexane, and optionally 0 to 30 phr of a general purpose plasticizer;
b. 1.5 to 5 phr of a viscosity modifier;
c. 100 phr of poly(vinyl chloride); and,
d. 150 to 250 phr of filler.

9. The plastisol of claim 8, wherein said plastisol exhibits a viscosity of <30,000 cP, an absence of dilatency by showing newtonian behavior over a range of shear, and a stability in excess of seven days as indicated by a viscosity increase of <10%.

10. A plastisol comprising:
a. 20 to 150 parts per hundred resin (phr) of a general purpose plasticizer;
b. optionally, 1 to 50 parts per hundred resin (phr) of a highly solvating plasticizer;
c. 1 to 50 parts per hundred resin (phr) of bis 1,4-(2-ethylhexyl)cyclohexane;
d. 0.25 to 5 phr of a viscosity modifier;
e. 100 phr of poly(vinyl chloride); and,
f. 1 to 400 phr of filler;
wherein said plastisol has a lower fusion temperature when compared to a plastisol containing only the general purpose plasticizer.

11. The plastisol of claim 10, comprising:
a. 40 to 100 parts per hundred resin (phr) of a general purpose plasticizer;
b. optionally, 5 to 40 parts per hundred resin (phr) of a highly solvating plasticizer;
c. 5 to 40 parts per hundred resin (phr) of bis 1,4-(2-ethylhexyl)cyclohexane;
d. 1 to 5 phr of a viscosity modifier;
e. 100 phr of poly(vinyl chloride); and,
f. 100 to 350 phr of filler;
wherein said plastisol has a lower fusion temperature when compared to a plastisol containing only the general purpose plasticizer.

12. The plastisol of claim 11 comprising:
a. 50 to 80 parts per hundred resin (phr) of a general purpose plasticizer;
b. optionally, 15 to 30 parts per hundred resin (phr) of a highly solvating plasticizer;
c. 5 to 10 parts per hundred resin (phr) of bis 1,4-(2-ethylhexyl)cyclohexane;
d. 1.5 to 5 phr of a viscosity modifier;
e. 100 phr of poly(vinyl chloride); and,
f. 0 to 400 phr of filler;
wherein said plastisol has a lower fusion temperature when compared to a plastisol containing only the general purpose plasticizer.
